(19) United States
(12) Patent Application Publication
(10) Pub. No.: US 2003/0164666 A1
(43) Pub. Date: Sep. 4, 2003

(54) Lamp reflect-reflector/reflect-reflector baffle

(76) Inventor: Paul D. Crunk, Taylor, MI (US)

Correspondence Address: Paul Crunk, 12220 WOODCREST, BOX 725, TAYLOR, MI, 48180, US

(21) Appl. No.: 10/085,858

(22) Filed: Mar. 1, 2002

(51) Int. Cl. H01J 5/16

(52) U.S. Cl. 313/113

(57) ABSTRACT

The present invention provides the art of having a reflect-reflector baffle placed inside a lamp on the underside of the front lens or at the bottom portion of the lamp directly on a PC board or the use of a reflect-reflector baffle insert placed in the lamp that surrounds a light bulb or one or more LEDs to help aid in the light illumination of the lighting element which would then increase the light output of the lamp by redirecting any and all the light being generated from the lighting element/s to be forced to come out through the front area of the lens, which would usually be lost with inside the lamp. The common problem usually found within many types of vehicle lamp is that the reflect reflector placed on the inside portion of the lens which prevents the light from coming out through the lens being produced by the lighting source inside the lamp. By using a reflect-reflector baffle and placing it at the bottom portion off the lamp that surrounds the light bulb or LED's or the lighting element allows all the lost light that would be absorbed within the lamp to be by forced/redirect all that light to come out directly through the lens viewing area allowing the human eye to see the lamp as being brighter and more full of light.

### FIELD OF THE INVENTION

A reflect-reflector or a reflect-reflector baffle located inside the lamp on the underside of the front lens or separate from the lens area or a combination of both that helps aid in the illumination of the lighting source in the lamp and also acts as a reflect-reflector to bounce back any light from motor vehicles back to the driver of those motor vehicles to be seen by the driver adding to better safety and visibility.

### BACKGROUND OF INVENTION

To this present day there has never been a lamp offered that has the reflect-reflector or reflect-reflector baffle placed inside the lamp that aids in the illumination source of the lamp and also acts as a reflect-reflector. The reflect-reflector is placed on face (the top surface) of the baffle or PCB board and can also be part of the underside of the front lens inside the lamp which helps the lamp to be seen when the lamp is not lit up during the day or during the nighttime when vehicles head light from automobile, truck or motorcycle are directed at the reflect-reflector contained within the lamp, which it then reflects back giving the appearance of a light being lit. This reflect-reflector baffle also significantly aids in the illumination of the light source inside the lamp by capturing the light that may get lost in the lamp and redirects it forward out of the lamp lens making the lamp that much brighter to the human eye. The problem is with most lamps are the light is lost or absorbed within the lamp case or PC board in the lamp which decreases the light output of the lamp. The reflect-reflector being part of the PCB board surface or a separate reflect-reflector baffle assembly placed in the lamp would takes any light being generated inside the lamp or any exterior light generating source produced by an on coming vehicle then can be seen by the drivers of that vehicle by redirect back out of the lamp to the driver of that vehicle. Having a reflect reflector being part of the inside portion of the lamp will help in replacing to use plastic reflectors and adhesive reflector tape on the rear and sides of vehicles for visibility and safety.

### SUMMARY OF INVENTION

The present invention relates to vehicle lighting used on many trucks and trailers, and many commercial applications used on an off the roadways worldwide that require a reflect-reflector to aid in illumination for safety reasons. The problem with many of these applications is they require a reflect-reflector adhesive tape or plastic reflectors to be placed on the vehicle to help illuminate the vehicle to other motorists showing the size and width of the vehicle to prevent collisions. The problem has been when a reflect-reflectors is when they are placed on the inside surface of many lamp lens, which considerably restricts the light being generated inside the lamp from exiting that lamp to be seen by other motorists. Most automobile lamps today using bulbs which have a reflect reflector placed on the inside portion of the lens area of the lamp. With the use a light bulb the reflect reflector does prevents the light from being seen through the lens on the outside of the lamp. This is why with a reflect-reflector baffle being placed at the bottom portion of the lamp will not restrict any light from exiting out of the lamp which the oncoming motorists can still see the reflect reflector through the lens. This new invention has solved two problems in combining them both within one lamp. The reflect-reflector is placed on the face of the reflector or baffle, which does not restrict any light from exiting the lamp to be seen by the human eye. As we all notice today most reflect-reflectors are placed on the interior or exterior of the lamp lens, which then reduces much of light output being produced with inside the lamp. Most all vehicle applications including automobiles, trucks and trailers require some sort reflect reflectors placed on the vehicle for added safety and the adhesive reflect reflector tape and plastic reflectors are most commonly used on the side and rear of many vehicles to aid in vehicle safety. The problem with many trucks, trailers and tow truck operators is they do not like having to use adhesive reflect reflectors and plastic reflect-reflectors placed on the vehicles because it takes away from the beauty of the vehicle having these many adhesive reflect reflector stuck to the side or the back of the vehicle. Many OEMs in aftermarket would prefer to put only a lamp with a built-in reflect reflector to replace the unsightly adhesive tape plastic reflect-reflectors and save time in assembly. The purpose of most reflect-reflectors is to be used mainly during nighttime hours to help illuminate both small or large vehicle to oncoming traffic in letting other motorists know the size of the vehicle where the vehicle located to prevent collision. The problem is that many of the trucking trailer manufacture do not like using the adhesive or plastic screw-on adhesive plastic reflect reflector's because it takes too much time to place them on the vehicles during manufacturing and it is very difficult to placed the adhesive reflect reflectors on the vehicle to make sure they are placed on straight. If they are not placed on the vehicle straight or in the right distances between each other and the lighting then it becomes very unsightly to human eye. There are many other obvious problems with adhesive tape reflect reflector's or screw on reflect-reflectors when the vehicle goes through automobile or truck washes that reflect reflector starts to break down peal off and loses its reflectivity on surface area. Another common problem is when grease and oil cover the reflect reflector adhesive tape it prevents the reflect reflector from being seen. With the use of the lamp reflect reflector baffle contained within lamp will help illuminate the lamp more brightly and evenly throughout the lamp by using the baffle reflect reflector to be seen more brightly. The reflect reflector baffle as two purposes by being placed with inside the lamp below or near the lighting source. The baffle reflect reflector helps by aiding in the compression of the light and bringing all the light forward through the front of the lens which would obviously be lost with inside the lamp. The baffle reflects reflector within the lamp has one or more optical reflectors, which is like having one or many flashlights inside one lamp source. The reflect reflector baffle can be used in many different sahpe LED applications which aids in the intensity of one or more LEDs. Using the reflect reflector baffle can considerably reduced the need of having to more LEDs within the LED lamp. When the optical design of the baffle reflector is designed accurately the LED lamp would then appear just as bright using less leds. The baffle reflector takes all the light being generated by a single LED or a few LEDs and forces all the light forward being generated by a LED or LED's to be seen through the lens and not to be lost or absorbed inside lamp. When LED's are being used they generate light 360 degrees all around the LED itself including the light coming from the bottom of the led. If all that light being generated from that LED was directed forward it would considerably increase that LED brightness which would allow lamp manufacturers to use less LED's to achieve the same brightness of using many LED's with no baffle or reflector.

### BRIEF DESCRIPTION OF THE DRAWING

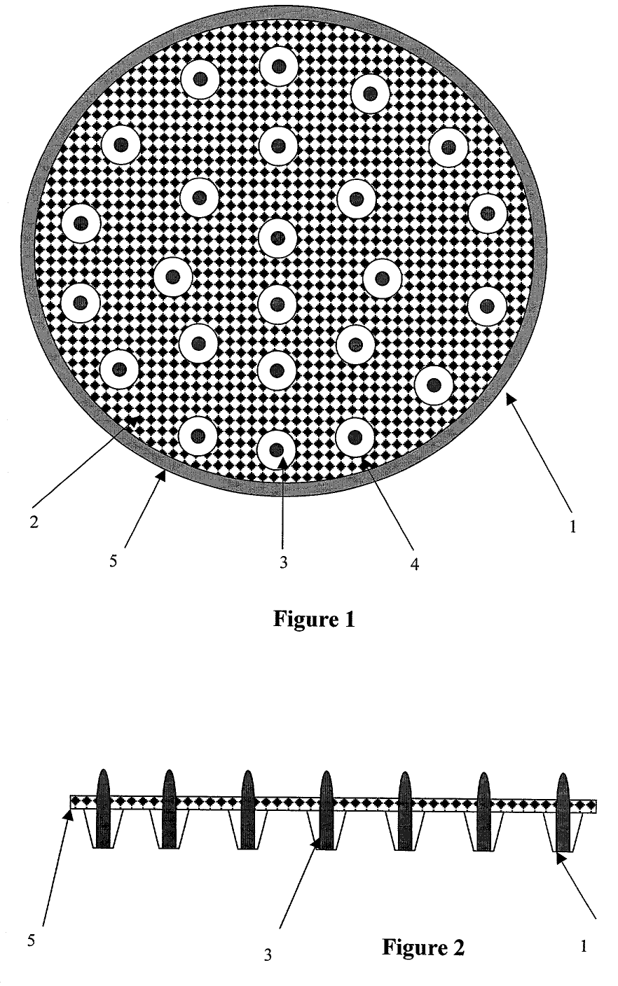

In FIG. 1 you can see the baffle reflect-reflector in 1 and the reflector in 2 and the ultrasonic area 5 and the baffle reflector 4 and the lighting element in 3.

In FIG. 2 you can see the area where this type of reflect-reflector baffle can be mounted using screws or ultrasonic welding or any other type of glue.

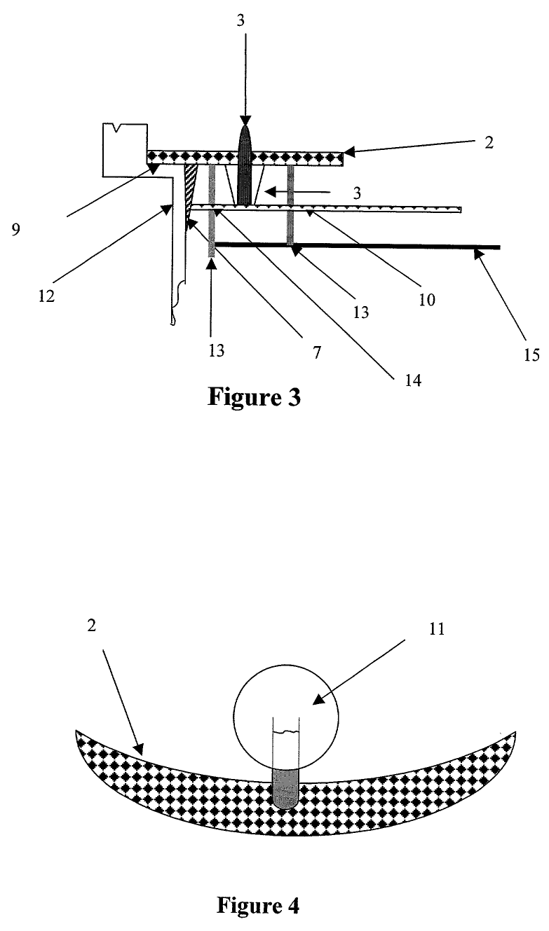

In FIG. 3 you can see the PCB 10 and the case wall 12 is where the wedge tab or tabs 7 is connected the reflect-reflector baffle edge which slides down between the case wall and the pcb 10 to prevent the pcb 10 from shifting vertical and horizontal and the reflector baffle 3 rest down on the pcb 2 to prevent the pcb 2 from shifting vertical. Also you can see the area 9 on the reflect-reflector baffle where is can be fastened using screws, ultrasonic welding or glues to the case 12 area. Also you can see the led 3 sticking up above the baffle reflector 3, which will allow the light from the led to bounce off the reflector area 2 and be directed out of the lamp to be seen.

In FIG. 4 you can see reflector 2 by adding a reflect-reflector to a small portion or the whole reflector 2 area under the light bulb 11, which will make the reflect-reflector be seen from other drivers and also the reflect-reflector baffle will also make the light bright to be seen through the front areas of the lens filling the whole lamp and lens are full light making the light that much brighter to be seen by other drivers.

### DETAILED DESCRIPTION OF DRAWINGS

Figure No. 1

A baffle reflect reflector 1 contains one or more baffles 4 with one or more lighting elements 3 which can be a light bulb 11 in FIG. 4 or LED 3 with a reflect reflector 2 which can be part of a PC board portion 10 of the LED board 10 or a separate reflect-reflector baffle 1, which can be inserted into the lamp that can contains one or more lighting elements 3 or light bulb 11 in FIG. 3.

The baffle reflect reflector 1 can also contain a area around the reflect reflector 2 where 5 can then be fastened using screws, ultrasonically welded or glue to the inside portion of the interior of the lamp to secure the PCB board in the interior of the lamp from vibrating horizontal or vertical with or without the use of screws, clips, barbs or pins that would need to be melted to secure the LED board or circuit board/s in place. The baffle can also contain a wedge 7 in FIG. 2 like feet or it can be a full circle wedge that can slide down in-between the pcb and the interior case wall of the lamp to prevent the pcb from shifting horizontal or vertical in the lamp. One additional feature of the reflect reflector baffle is that it can have additional feet or wedges 13 that can go through the led pcb to press down and prevent the controller pcb board from shifting horizontal or vertical which can also replace the use of any sort of fasteners. This is an improvement to Paul Crunk's Light Board Retainer Ring patent which allows greater fastening of the PCB's using the reflect reflector baffle where the cone shaped reflectors on the baffle rest pressing down on the LED PCB preventing it from vibrating up-and-down and side to side, and the wedge 7 areas underneath the reflect-reflector baffle 1 slides in between the LED PCB board and the case 7 which also prevents the LED board from shifting side to side and up and down when the lamp is under considerable vibration. The reflect reflector baffle can be made in such away that it can also have securing posts 13 to go through the LED PC board 14 to secure controller board 15 underneath the LED PCB 10 from shifting left or right or up and down.

What is claimed is:

1 A reflect-reflector baffle or reflect-reflector in any shape form or design placed inside the lamp under of the lens to reflect interior and exterior light out of the lamp to be seen by other motor vehicle drivers.

2 a reflect-reflector baffle or reflect-reflector placed inside the a light bulb lamp or LED lamp under the front lens, or can be part of the front lens or attached in any way to the front lens or can include a combination of both being part of the underside of the front lens and placed under the lens, which aids in the illumination of the lighting element or elements to reflect all light being generated inside of the lamp or any exterior light outside of the lamp aimed at the lamp to be reflected out of the lamp be seen by the human eye.

3 a reflect reflector baffle placed inside a lamp to help keep one or more PCB boards from shifting horizontal or vertical fastened to the inside of the lamp.

4 Dependant on claim 2 a reflect reflector baffle with one or more cone shape optical baffles and reflect-reflectors that surrounds one or more light bulbs or LEDs, which helps in redirecting and amplifying the light being generated by the light source and forces all the light forward through the front of the lens to be seen by the human eye.

5 Dependent on claim 2 a reflect reflector baffle which facilitate in lighting up the entire interior of the lamp, which would allow the human eye to see a much fuller look of light filling the lamp interior lighting surface areas and lens area making the lamp look like it is glowing inside leaving no dark areas to be seen.

6 Dependent on claim 1 a reflect reflector baffle, which can fill a portion of a single light bulb reflector area or a portion of the surface of the reflect-reflector baffle used in light bulb or LED lamps, which then would captures the headlight light being sent to the reflect-reflector and return that light back to the human eye of the driver of that motor vehicle where it can be seen.

7 dependent on claim 1 a reflect reflector baffle is placed on the surface of the of the led PCB which reflect the light from the light generating source inside the lamp out of the lamp and also reflects the light back to an exterior light generating source to be seen by the human eye.
